(19) United States
(12) Patent Application Publication
(10) Pub. No.: US 2013/0107014 A1
(43) Pub. Date: May 2, 2013

(54) IMAGE PROCESSING DEVICE, METHOD, AND RECORDING MEDIUM THEREOF

(71) Applicant: FUJIFILM Corporation, Tokyo (JP)

(72) Inventor: Tomonori MASUDA, Saitama-shi (JP)

(73) Assignee: FUJIFILM CORPORATION, Tokyo (JP)

(21) Appl. No.: 13/724,971

(22) Filed: Dec. 21, 2012

Related U.S. Application Data
(63) Continuation of application No. PCT/JP2011/066302, filed on Jul. 19, 2011.

(30) Foreign Application Priority Data
Jul. 26, 2010 (JP) 2010-167301

(51) Int. Cl. H04N 13/02

(52) U.S. Cl. CPC H04N 13/0239
USPC 348/47

(57) ABSTRACT

According to a parallax adjustment of a stereoscopic video, an original parallax is prevented from being significantly spoiled. In the present invention, in a case where a parallax width of the stereoscopic video does not conform to an output permissible parallax width, the stereoscopic video is separated into a plurality of scenes, whether or not a scene parallax width conforms to the output permissible parallax width for each scene is determined, and a representative parallax of the scenes is adjusted according to the determination result. Without the whole parallax widths of the stereoscopic video being uniformly adjusted, the parallax widths are adjusted for each scene. Therefore, the stereoscopic effect of the stereoscopic video can be prevented from being entirely lost.

### BACKGROUND OF THE INVENTION

1. Field of the Invention

The present invention relates to an image processing device, and particularly to a binocular parallax adjustment for each stereoscopic image frame of a stereoscopic video.

2. Description of the Related Art

A stereoscopic image processing device disclosed in JP2004-221699A includes a two-dimensional image generation unit and a stereoscopic effect adjustment unit that adjusts stereoscopic effects of stereoscopic images displayed to a user. In such a stereoscopic image processing device, when a displayed subject reaches limit parallax, the stereoscopic effect adjustment unit responds thereto, and according to acquired appropriate parallax information, a parallax control unit generates parallax images so as to realize the related appropriate parallax in the subsequent stereoscopic display. At this time, a parallax control is realized by optimally setting camera parameters retroactive to three-dimensional data. In addition, the two-dimensional image generation unit calculates a depth Fxy satisfying the appropriate parallax. When depth ranges are set as K1 to K2 and a depth value of each image is set as Gxy, such depth Fxy is obtained by an equation “Fxy=J1+(Gxy−K1)×(J2−J1)/(K2−K1)”. Here, if Fxy is not an integer, rounding to the nearest whole number or a process decreasing the approximate parallax is performed.

### SUMMARY OF THE INVENTION

However, if the stereoscopic video using the parallax is not displayed with an appropriate parallax amount, it may cause fatigue to viewers. Since the appropriate parallax amount varies according to display size, stereoscopic fusion limits of the viewers or the like, it is necessary to adjust the parallax.

As a result of the parallax adjustment, if the stereoscopic images are regenerated with parallax different from the parallax at the time of photographing, it may give a sense of incompatibility to the viewers. For this reason, it is preferable to adjust the parallax so as to keep the original parallax of the stereoscopic video at the time of photographing as far as possible.

In JP2004-221699A, since the depth Fxy satisfying the appropriate parallax is calculated and then rounded to the nearest whole number, the parallax between frames become the same as each other, and the stereoscopic effect change according to frame transition cannot be felt, or on the contrary, great parallax changes attached excessively between frames may induce fatigue in the viewers.

An object of the present invention is to prevent the original parallax from being significantly spoiled by adjusting the parallax of the stereoscopic video.

The present invention provides an image processing device which includes a representative parallax acquisition unit that acquires a representative parallax from a plurality of stereoscopic image frames configuring the whole or a predetermined partial range of a stereoscopic video; a scene separation unit that separates the stereoscopic video into a plurality of scenes, in a case where a parallax width stipulated by a maximum value and a minimum value of the representative parallax of each stereoscopic image frame acquired by the representative parallax acquisition unit does not conform to a permissible parallax width stipulated by a predetermined maximum permissible parallax width and minimum permissible parallax width; a parallax adjustment unit that determines whether or not the scene parallax width stipulated by the maximum value and the minimum value of the representative parallax of the stereoscopic image frames configuring the scenes conforms to the permissible parallax width, for each scene separated by the scene separation unit, and that uniformly adjusts the representative parallax of each stereoscopic image frame configuring the scenes according to the determining result so as to conform to the permissible parallax width; and an output unit that outputs the stereoscopic image frame of which the representative parallax is adjusted by the parallax adjustment unit. Here, the “representative parallax” described above, for example, represents the representative parallax within the stereoscopic video frames, such as the representative parallax of a target subject or the like within the stereoscopic video frames.

In addition, the parallax adjustment unit may adjust the representative parallax of each stereoscopic image frame configuring an arbitrary scene so as to be equal to or lower than an upper limit of the representative parallax, in a case where scene parallax width of the arbitrary scene conforms to the permissible parallax width, but the maximum value of the representative parallax of the stereoscopic image frames configuring the arbitrary scene exceeds the upper limit of a predetermined representative parallax.

Further, the parallax adjustment unit may uniformly adjust the representative parallax so that the representative parallax of each stereoscopic image frame configuring two or more consecutive scenes may be equal to or lower than the upper limit of the representative parallax, in a case where the parallax width of each scene corresponding to two or more consecutive scenes conforms to the permissible parallax width, but the maximum value of the representative parallax of the stereoscopic image frames configuring the two or more consecutive scenes exceed the upper limit of the representative parallax.

Further, the parallax adjustment unit may adjust the representative parallax of each stereoscopic image frame configuring an arbitrary scene so as to be equal to or higher than a lower limit of the representative parallax, in a case where the scene parallax width of the arbitrary scene conforms to the permissible parallax width, but the minimum value of the representative parallax of the stereoscopic image frames configuring the arbitrary scene is less than the lower limit of a predetermined representative parallax.

In addition, the parallax adjustment unit may adjust the representative parallax of each stereoscopic image frame configuring the arbitrary scene so as to be equal to or higher than a lower limit of the representative parallax, in a case where the scene parallax width of the arbitrary scene conforms to the permissible parallax width, but the minimum value of the representative parallax of the stereoscopic image frames configuring the arbitrary scene is less than the lower limit of the predetermined representative parallax.

In addition, the scene separation unit separates the stereoscopic video according to a first predetermined reference and a second reference other than the first predetermined reference, in a case where scene parallax widths of scenes separated according to the first predetermined reference are not conformed to the permissible parallax width.

In addition, the second reference may have a lower estimation accuracy of the scene change than that of the first reference.

Further, the parallax adjustment unit may determine whether or not the scene parallax width of the scenes conforms to the permissible parallax width, for each scene separated by the scene separation unit according to the first reference and the second reference, and adjusts the representative parallax of each stereoscopic image frame configuring the scenes so as to conform to the permissible parallax width, in a case where it is determined that the scene parallax width of the scenes does not conform to the permissible parallax width.

In addition, the parallax adjustment unit may smooth a representative parallax adjustment amount between the two adjacent scenes, in a case where a difference of the representative parallax adjustment amount between the two adjacent scenes exceeds a predetermined threshold value.

In addition, the present invention may provide an acquisition step of acquiring a representative parallax for a plurality of stereoscopic image frames configuring the whole or a predetermined partial range of a stereoscopic video; a separation step of separating the stereoscopic video into a plurality of scenes, in a case where a parallax width stipulated by a maximum value and a minimum value of the representative parallax of each stereoscopic image frame acquired by the representative parallax acquisition unit does not conform to a permissible parallax width stipulated by a predetermined maximum permissible parallax width and a predetermined minimum permissible parallax width; an adjustment step of determining whether or not the scene parallax width stipulated by the maximum value and the minimum value of the representative parallax of each stereoscopic image frame configuring the scenes conforms to the permissible parallax width, for each scene separated by the scene separation unit, and of uniformly adjusting the representative parallax of each stereoscopic image frame configuring the scenes according to the determining result so as to conform to the permissible parallax width; and an output step of outputting the stereoscopic image frame of which the representative parallax adjusted.

Further, the present invention may provide a non-transitory computer-readable recording medium using the image processing device according to claim 1, which stores an image processing program for performing: an acquisition step of acquiring a representative parallax for a plurality of stereoscopic image frames configuring the whole or a predetermined partial range of a stereoscopic video; a separation step of separating the stereoscopic video into a plurality of scenes, in a case where a parallax width stipulated by a maximum value and a minimum value of the representative parallax of each stereoscopic image frame acquired by the representative parallax acquisition unit does not conform to a permissible parallax width stipulated by a predetermined maximum permissible parallax width and a predetermined minimum permissible parallax width; a adjustment step of determining whether or not the scene parallax width stipulated by the maximum value and the minimum value of the representative parallax of each stereoscopic image frame configuring the scenes conforms to the permissible parallax width, for each scene separated by the scene separation unit, and of uniformly adjusting the representative parallax of each stereoscopic image frame configuring the scenes according to the determining result so as to conform to the permissible parallax width; and an output step of outputting the stereoscopic image frame of which the representative parallax is adjusted.

According to the present invention, in a case where the parallax width of the stereoscopic video does not conform to the output permissible parallax width, the stereoscopic video is separated into plural scenes, and then it is determined whether or not the scene parallax width conforms to the output permissible parallax width for each scene, and the representative parallax of the scenes are adjusted according to the determination result. Without the whole parallax widths of the stereoscopic video being uniformly adjusted, the parallax widths are adjusted for each scene. Therefore, the stereoscopic effect of the stereoscopic video can be prevented from being entirely lost.

### BRIEF DESCRIPTION OF THE DRAWINGS

FIG. 1 is a front perspective view of a digital camera.

FIG. 2 is a rear perspective view of a digital camera.

FIG. 3 is a block diagram of a digital camera.

FIGS. 4A and 4B are schematic views illustrating parallax limits in the divergence direction.

FIG. 5 is a flowchart illustrating a parallax adjustment process.

FIG. 6 is a view illustrating an example of a conversion table between a representative parallax and output parallax of a stereoscopic video.

FIGS. 7A to 7C are schematic views illustrating parallax shifts according to a first embodiment.

FIG. 8 is a block diagram illustrating a display reproducing device.

FIGS. 9A to 9C are schematic views illustrating parallax shifts according to a second embodiment.

### DESCRIPTION OF THE PREFERRED EMBODIMENTS

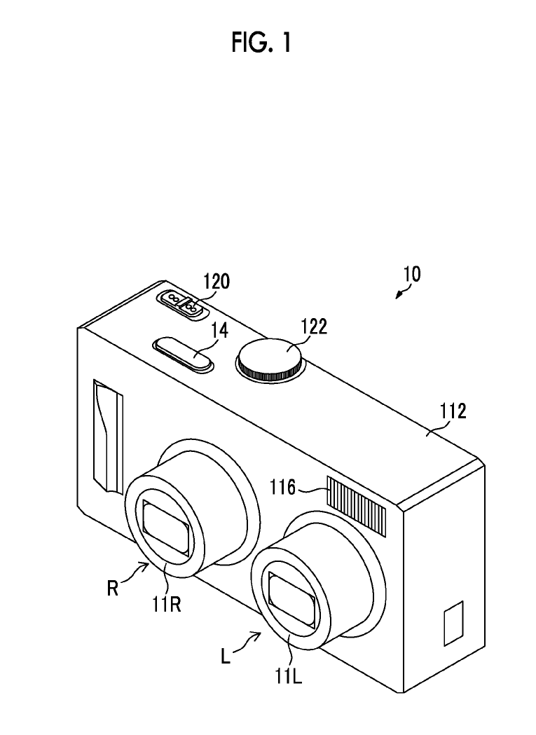

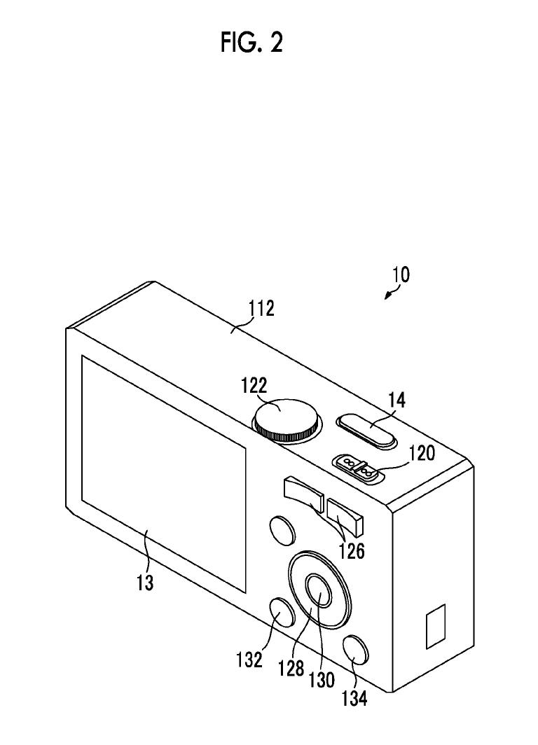

FIG. 1 is a front perspective view illustrating an external structure of a digital camera 10 according to an embodiment of the present invention. FIG. 2 is a rear perspective view illustrating an external structure of an example of the digital camera.

The digital camera 10 includes plural imaging means (two imaging means are illustrated in FIG. 1), and can photograph a subject from plural viewpoints (two right and left viewpoints illustrated in FIG. 1). In addition, in the present example a case with two imaging means is described for the convenience of the description. However, the present invention is not limited thereto and may also be similarly adapted to a case with three or more imaging means.

A camera body 112 of the digital camera 10 according to the present example is formed in a rectangular box shape, and as illustrated in FIG. 1, a pair of photography optical systems 11R and 11L, and a strobe 116 are installed on a front surface of the camera body. In addition, a release button 14, a power supply/mode switch 120, a mode dial 122 and the like are installed on an upper surface of the camera body 112. In addition, as illustrated in FIG. 2, a monitor 13 configured by a liquid crystal device (LCD), a zoom button 126, a cross button 128, a MENU/OK button 130, a DISP button 132, a BACK button 134 and the like are installed on a back surface of the camera body 112. The monitor 13 may be embedded in the digital camera 10 or may be an external device.

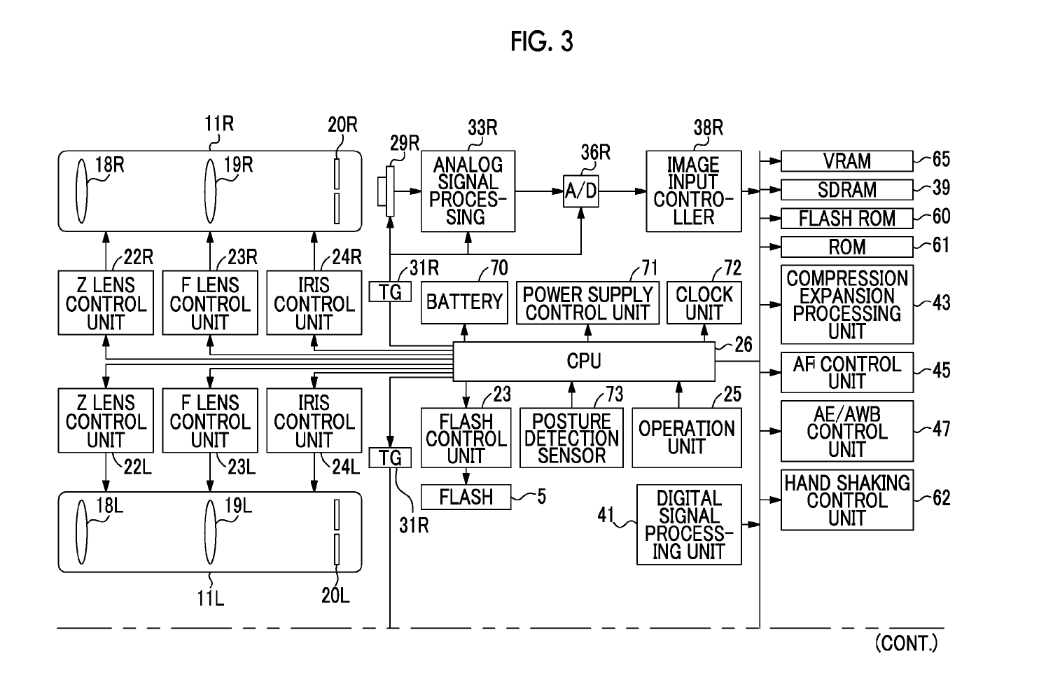

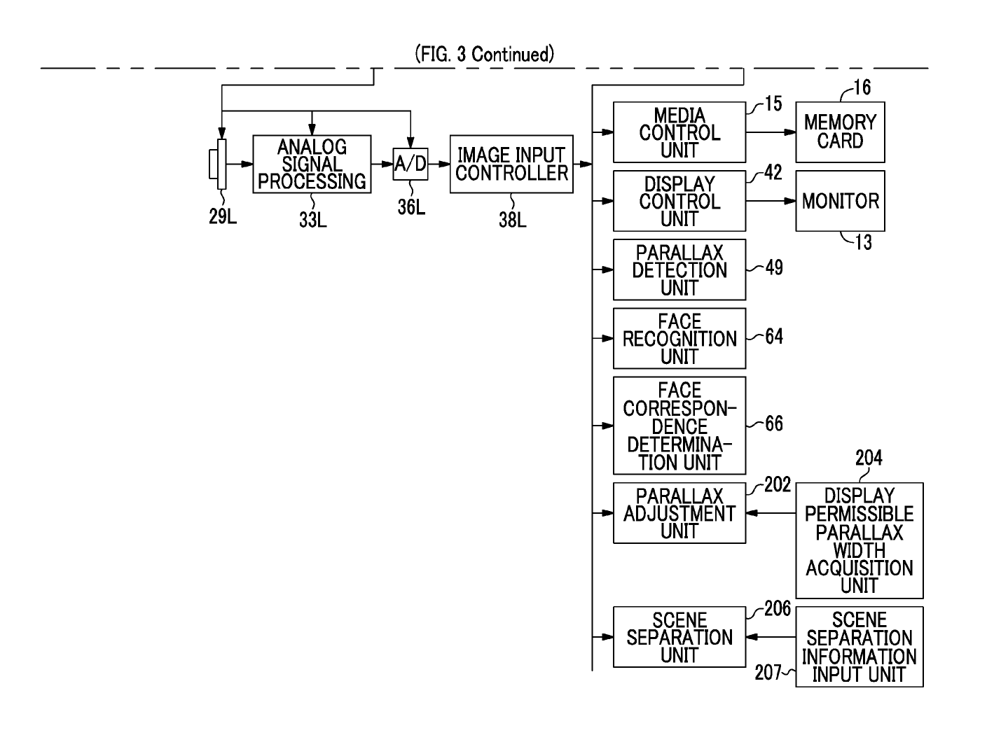

A pair of right and left photography optical systems 11R and 11L is configured to include respective retractable zoom lenses (18R and 18L in FIG. 3), and extracted from the camera body 112 when the power of the digital camera 10 is turned on. In addition, since a zoom mechanism or a retraction mechanism of the photography optical systems is a known technique, hereinafter the specific description thereon will be omitted.

The monitor 13 is a display device such as a color liquid crystal panel in which a so-called lenticular lens having a semi-cylindrical lens group is disposed on the front surface. Such a monitor 13 is used as an image display unit for displaying a photographed image, and used as a GUI for various settings. In addition, the monitor 13 through-displays images captured by an imaging device when photographing, and is used as an electronic viewfinder. Here, a stereoscopic image displaying method of the monitor 13 is not limited to a parallax barrier method. For example, the stereoscopic image displaying method using glasses such as an anaglyph method, a polarization filter method, and a liquid crystal shutter method may be used for the monitor 13.

The release button 14 is configured by a two-step stroke type switch in which so-called “half press” and “full press” are provided. The digital camera 10 performs a photography preparation process, that is, respective processes of AE (Automatic Exposure), AF (Auto Focus), and AWB (Automatic White Balance) when the release button 14 is half-pressed, at the time of a still image photography (for example, when a still image photography mode is selected using the mode dial 122 or the menu button), and performs image photographing and recording process when the release button 14 is full-pressed. In addition, the digital camera 10 starts a stereoscopic video photography when the release button 14 is fully pressed at the time of a stereoscopic video photography (for example, when a stereoscopic video photography mode is selected using the mode dial 122 or the menu button), and finishes the stereoscopic video photography when the release button 14 is fully pressed again. Here, when the release button 14 is fully pressed by a setting, a stereoscopic video photography may be performed, and when the release button 14 is released from the full-press state, the stereoscopic video photography may be finished. Here, a release button dedicated to photographing still images and a release button dedicated to photographing stereoscopic video may be provided.

The power supply/mode switch 120 (a power supply switch and a mode switch) functions as a power supply switch of the digital camera 10, and also functions as switching means for switching a playback mode and a photography mode of the digital camera 10. The mode dial 122 is used for setting the photography mode. The digital camera 10 sets a two-dimensional still image photography mode to photograph two-dimensional still images by setting this mode dial 122 to “two-dimensional still image position”, and sets a three-dimensional still image photography mode to photograph three-dimensional still images by setting this mode dial 122 to “three-dimensional still image position”. Furthermore, the digital camera 10 sets the three-dimensional still image photography mode to photograph three-dimensional still images by setting this mode dial 122 to “three-dimensional still image position”

The zoom button 126 is used for a zoom operation of the photography optical systems 11R and 11L, and configured by both a zoom tele-button for instructing a telephoto zoom and a zoom wide button for instructing a wide angle zoom. The cross button 128 is installed so as to be capable of a pressing operation in four directions of vertically and horizontally and functions according to the setting state of the camera are allocated for the pressing operation in each direction. The MENU/OK button 130 is used for calling a menu screen (MENU function), and used for confirming selected contents, and instructing a process execution and the like (an OK function). The DISP button 132 is used for inputting a display contents switching instruction and the like of the monitor 13. The BACK button 134 is used for inputting instructions such as input operation cancellation and the like.

FIG. 3 is a block diagram illustrating a main portion of the digital camera 10.

The digital camera 10 includes right eye point imaging means having a right eye point photography optical system 11R and an imaging element right eye point 29R, and left eye point imaging means having a left eye point photography optical system 11L and an imaging element left eye point 29L.

Each of the two photography optical systems 11 (11R and 11L) includes zoom lenses 18 (18R and 18L), focus lenses 19 (19R and 19L) and irises 20 (20R and 20L). The zoom lenses 18, focus lenses 19 and irises 20 are respectively driven by zoom lens control units 22 (22R and 22L), focus lens control units 23 (23R and 23L) and iris control units 24 (24R and 24L). The respective control units 22, 23 and 24 are configured by stepping motors, and controlled by drive pulses received from unillustrated motor drivers connected to a CPU 26.

CCD image sensors (hereinafter, referred to as CCD's) 29 (29R and 29L) are disposed in the rear of the two photography optical systems 11 (11R and 11L). Here, Instead of the CCD's 29, MOS type image sensors may be used. Each of the CCD's 29, as known, includes a photoelectric conversion surface on which plural photoelectric conversion elements are aligned, the subject light is incident on the photoelectric conversion surfaces through the photography optical systems 11, and thereby an image of the subject is captured. The CCD's 29 are connected to timing generators TG31 (31R and 31L) which are controlled by the CPU 26, and shutter speed (charge accumulation time of each photoelectric conversion element) of an electronic shutter is determined by timing signals (clock pulses) input by the timing generators TG31.

Imaging signals output from the CCD's 29 are input to analog signal processing circuits 33 (33R and 33L). The analog signal processing circuits 33 include correlation double sampling circuits (CDS's), amplifiers (AMP's) and the like. The CDS's generate image data of R, and B corresponding to charge accumulation time of each image from the imaging signals. The AMP's amplify the generated image data.

The AMP's function as sensitivity adjustment means for adjusting sensitivity of the CCD's 29. ISO sensitivities of the CCD's 29 are determined by gains of the AMP's. A/D converters 36 (36R and 36L) convert the amplified image data from an analog state to a digital state. The digital image data output from the A/D converters 36 (36R and 36L), through image input controllers 38 (38R and 38L), is temporarily stored in a SDRAM 39 which is a working memory, as a right eye point image data and left eye point image data, respectively.

A digital signal processing unit 41 reads out digital data from the SDRAM 39, performs various image processing such as grayscale conversion, white balance correction, γ correction processing, and YC conversion processing, and then stores the processed image data in the SDRAM 39 again. The image data of which image processing is finished by the digital signal processing unit 41 is acquired as through-images in a VRAM 65, and then converted into analog signals used for video output by a display control unit 42, and displayed on the monitor 13. In addition, the image data of which image processing is finished and acquired by the full-press of the release button 14 is compressed in a predetermined compression format (for example, a JPEG format) by a compression expansion processing unit 43, and then recorded on a memory card 16 as images for recording through a media control unit 15.

An operation unit 25 performs various operations for the digital camera 10, and is configured by the various buttons and switches 120 to 134 illustrated in FIGS. 1 and 2.

The CPU 26 is provided to integrally control the digital camera 10. The CPU 26 controls all units such as a battery 70, a power supply control unit 71 and a clock unit 72 based on various control programs stored in a flash ROM 60 or a ROM 61, setting information or an input signal or the like from a posture detection sensor 73 or the operation unit 25.

In addition, the digital camera 10 includes an AE/AWB control unit 47 for controlling AE (Auto Exposure)/AWB (Auto White Balance), and a parallax detection unit 49 for detecting the representative parallax of each of a plurality of stereoscopic image frames. In addition, the digital camera 10 includes a flash control unit 23 for controlling light emission timing and light emission quantity of a flash 5.

When the release button 14 is half pressed, the AE/AWB control unit 47 analyzes the images (captured images) obtained by the CCD's 29, and calculates iris values of the irises 20 and the shutter speeds of the electronic shutters of the CCD's 29 based on the brightness information and the like on the subject. Then, the AWB control unit 47 controls the iris values through the iris control units 24, and controls the shutter speeds through the TG31 based on this calculation result.

For example, the iris values and the shutter speeds of both photography optical systems 11R and 11L are calculated based on the captured images (right viewpoint images or left viewpoint images) obtained by the CCD 29R or 29L any one of the two photography optical systems 11R and 11L. The iris values and the shutter speeds of the photography optical systems 11R and 11L may be respectively calculated based on the captured images (the right eye point images and the left eye point images) obtained by the two photography optical stems 11R and 11L.

When the release button 14 is half pressed, an AF control unit 45 performs an AF search control that calculates contrast values by moving the focus lenses 19R and 19L along an optical axis direction, and performs a focus control that moves the focus lenses 19R and 19L to focus lens positions based on the contrast values. Here, the contrast values are calculated based on the image signals in a predetermined focus evaluation value calculation area of the captured images obtained by the CCD's 29R and 29L. “The focus lens positions” are the positions of the focus lenses 19R and 19L when the focus lenses 19R and 19L focus on at least a main subject.

For example, while at least one of the focus lenses 19R and 19L in the two photography optical systems 11R and 11L is moved by driving a motor driver 27R or 27L, the contrast value is calculated in the captured images (right viewpoint images or left viewpoint images) either photography optical systems 11R and 11L. Based on the contrast value, the focus lens positions of the focus lenses 19R and 19L in the two photography optical systems 11R and 11L are respectively decided, the motor drivers 27R and 27L are respectively driven, and respective focus lenses 19R and 19L are moved to respective focus lens positions. The respective two photography optical systems 11R and 11L may perform the AF search to decide the focus lens positions.

The posture detection sensor 73 detects a direction and an angle where the photography optical systems 11R and 11L are rotated with respect to a predetermined posture.

A hand shaking control unit 62 drives unillustrated correction lenses installed in the photography optical systems 11R and 11L by using motors, and prevents the hand shaking by correcting misalignment of the optical axis detected by the posture detection sensor 73.

The CPU 26 controls a face recognition unit 64 so as to recognize a face from the left and right image data corresponding to a subject image in the photography optical systems 11R and 11L. The face recognition unit 64 starts face recognition according to the control of the CPU 26, and respectively recognizes the face from left and right image data. As a result of the face recognition, the face recognition unit 64 stores face region information including position information of the face region respectively recognized from the left and right image data, into the SDRAM 39. The face recognition unit 64 can recognize the face region from the images stored in the SDRAM 39 in a well-known method such as template matching.

A face correspondence determination unit 66 determines a correspondence relationship between a face region recognized from the right image data and a face region recognized from the left image data. That is, the face correspondence determination unit 66 specifies a pair of face regions where the position information items of the face regions respectively recognized from the left and right image data are closest to each other. As a result, the face correspondence determination unit 66 matches the image information of the each face region configuring a pair of the face regions, and when identity accuracy for both of them exceed a predetermined threshold value, the face region configuring the pair is determined to be in correspondence relationship with each other.

The parallax detection unit 49 calculates the representative parallax between predetermined regions in the left and right image data.

For example, the representative parallax is calculated in the following manner. First, the parallax detection unit 49 calculates a position difference (a distance between correspondence points) between specified points (the correspondence points) corresponding to the face regions configuring the pair. Then, the parallax detection unit 49 calculates parallax average value for the points included in the face regions of the pairs, and sets the parallax average value as the representative parallax of the pair. When there is a plurality of the face regions determined to be in the correspondence relationship with each other, the parallax detection unit 49 calculates the representative parallax in a main face region between the face regions, and stores the representative parallax of the main face region in the SDRAM 39. The main face region includes a face region closest to the center of a screen, a face region closest to a focus evaluation value calculation area, a face region having the largest size and the like.

Alternatively, the parallax detection unit 49 calculates for example predetermined regions which are in the correspondence relationship between the right and left images, the parallax average value between the correspondence points in the image center portion or the focus evaluation value calculation area, and sets the average value as the representative parallax of the pair.

The position information of the predetermined regions which are in the correspondence relationship and the representative parallax thereof are stored in the SDRAM 39 by being corresponded to the left and right image data. For example, the position information of the face regions which are in the correspondence relationship and the representative parallax thereof are stored as incidental information (a header, a tag, meta information and the like) of the image data. When the image data are recorded in a compressed state as images for recording in the memory card 16, the position information on the face regions and the representative parallax is combined with each other and then are recorded in the incidental information on the images for recording as tag information such as Exif, for example.

A display permissible parallax width acquisition unit 204 acquires a minimum display permissible parallax Dmin and a maximum display permissible parallax Dmax, and input them to a parallax adjustment unit 202. The minimum display permissible parallax Dmin and the maximum display permissible parallax Dmax may be arbitrarily acquired. For example, the minimum display permissible parallax Dmin and the maximum display permissible parallax Dmax may be input by the operation unit 25, or by the ROM 61, the incidental information of the stereoscopic video data or the like, and may be input by the monitor 13 as control information.

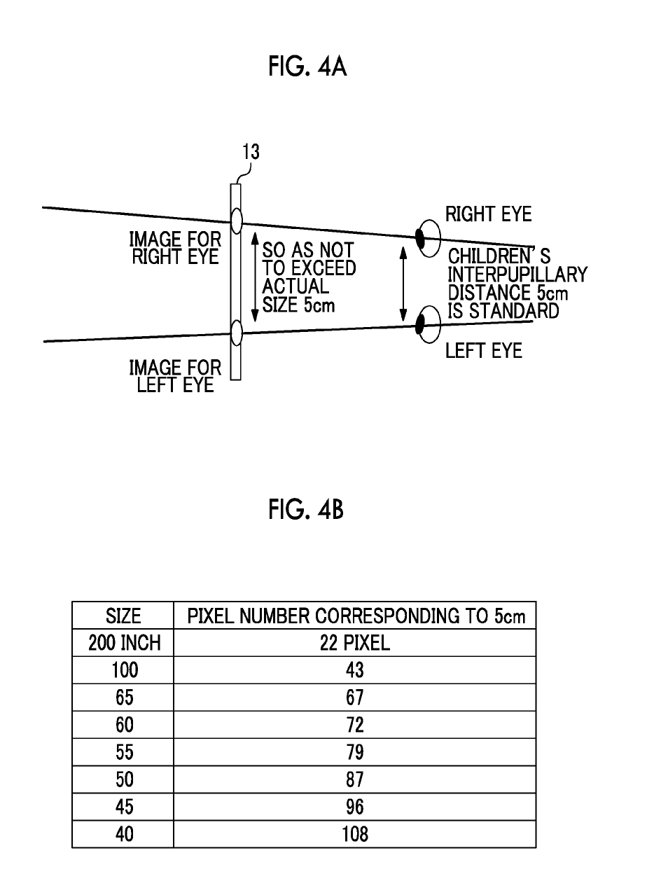

The maximum display permissible parallax Dmax defines parallax limit in the divergence direction (the direction in which stereoscopic images on the monitor 13 are retracted). As illustrated in FIG. 4A, since human eyes are not open outward the left and right images having the parallax exceeding interpupillary distance are not fused, and a viewer cannot recognize them as a single image, thereby causing eyestrain. Considering children viewers, the interpupillary distance is approximately 5 cm, and thus the pixel number of the monitor 13 corresponding to the interpupillary distance becomes the maximum display permissible parallax Dmax. For example, if the monitor 13 is a high vision television of 16:9 inch size and has a resolution of 1920×1080, the minimum display permissible parallax Dmin of the monitor 13 for each size is as illustrated in FIG. 4B. If the monitor 13 has a small size like a screen embedded in a digital camera or a cellular phone, the parallax in the divergence direction does not cause a problem. But if the monitor 13 has a large size screen like a television, the parallax in the divergence direction causes a problem.

The minimum display permissible parallax Dmin defines the limit of excessive parallax (in the direction to which stereoscopic images protrude on the monitor 13). The minimum display permissible parallax Dmin cannot be uniquely decided from the interpupillary distance unlike the maximum display permissible parallax Dmax. For example, as an output condition for determining the minimum display permissible parallax Dmin, there are (1) a size of the monitor 13, (2) a resolution of the monitor 13, (3) a viewing distance (a distance from a viewer to the monitor 13), and (4) a stereoscopic fusion limit of an individual viewer.

As a standard example, (2) the resolution of the monitor 13 of the high vision television is 1,920×1,080, (3) the viewing distance is three times the screen height of the monitor 13. Assuming these, and (4) a general stereoscopic fusion limit is 57 pixels (a parallax angle is approximately one degree). A threshold setting unit 205 may input information (1) to (4) from the outside based on a user is operation, setting information of the monitor 13 or the like. For example, the user can input the resolution of the monitor 13 which the user views, the viewing distance, and the stereoscopic fusion limit through the operation unit 25. However, if the information (2) to (4) is not input from the outside in particular, the above-described standard example is input to the parallax adjustment unit 202 by the threshold setting unit 205, after being read out from the ROM 61 or the like.

The parallax adjustment unit 202 adjusts so that the representative parallax width of the left and right image data may fall in the width of the display permissible parallax formed from the minimum display permissible parallax Dmin to the maximum display permissible parallax Dmax.

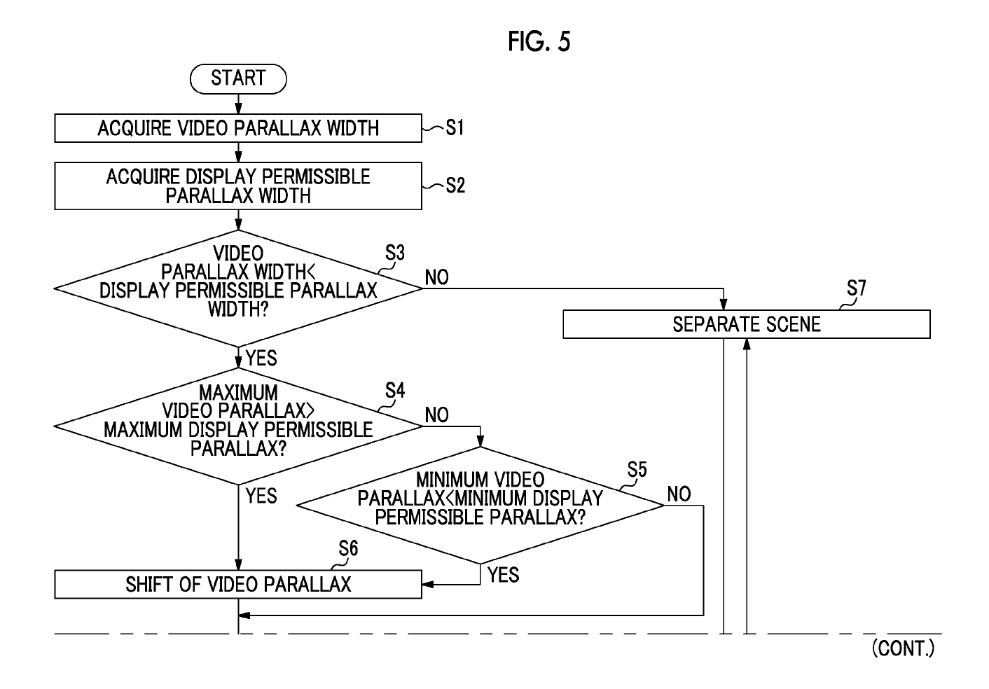

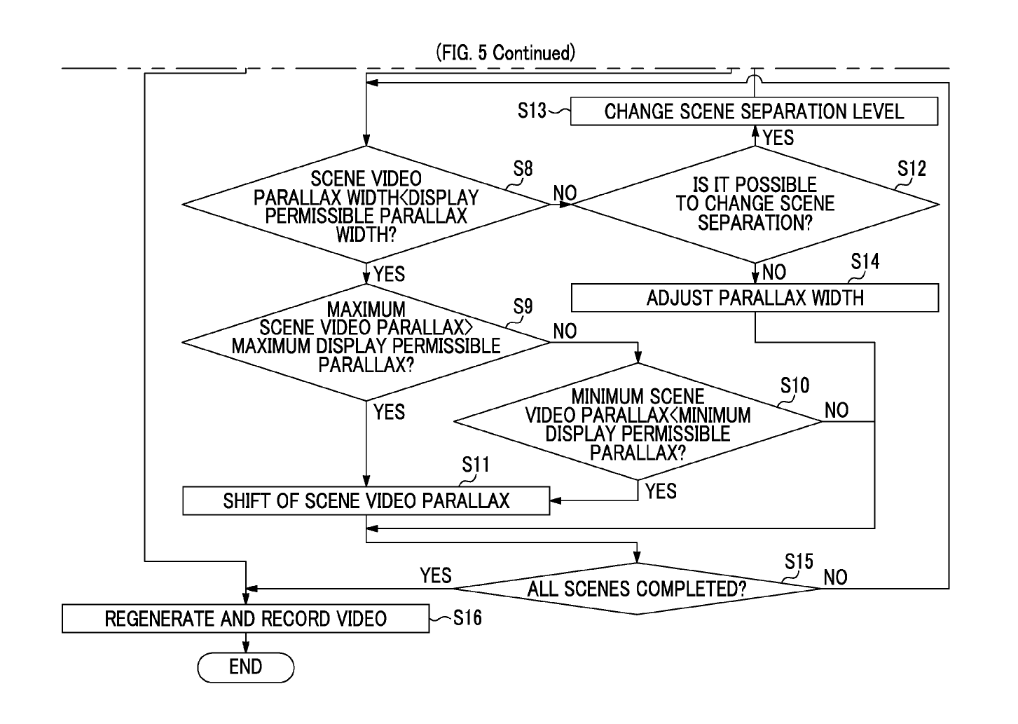

FIG. 5 illustrates a flowchart of a parallax adjustment process. The parallax adjustment process is controlled by the CPU 26. A program for executing the parallax adjustment process of the CPU 26 is recorded on a computer-readable recording medium such as the ROM 61. This parallax adjustment process is executed after the position information on the above-described regions and the representative parallax is stored in the incidental information of the image data.

In step S1, the parallax adjustment unit 202 attempts to read out the representative parallax fir each stereoscopic video frame, from the left and right image data of each stereoscopic video frame configuring the whole or a predetermined partial range of the stereoscopic video stored in the SDRAM 39 or the memory card 16 and the incidental information of the stereoscopic video frame. The predetermined partial range of the stereoscopic video may be assigned by the operation unit 25, and may be stipulated in the ROM 61 or the like. The predetermined partial range is also arbitrary for the position and length unit, and may be assigned by a frame number, photographing time, a time interval, the number of frames or the like.

In step S2, the display permissible parallax width acquisition unit 204 acquires the display permissible parallax width from the SDRAM 39. The display permissible parallax width represents a range from the minimum display permissible parallax Dmin to the maximum display permissible parallax Dmax. An acquisition source for the display permissible parallax width includes the operation unit 25, the embedded ROM 61, the external monitor 13, an electronic device or the like.

In step S3, the parallax adjustment unit 202 specifies a representative parallax maximum value pmax and a representative parallax minimum value pmin from the representative parallax of each stereoscopic image frame, and calculates a stereoscopic video parallax width by adding the representative parallax maximum value pmax to the representative parallax minimum value pmin. Then, the parallax adjustment unit 202 determines whether the stereoscopic video parallax width is less than the display permissible parallax width” or not. If the answer is Yes, the process proceeds to step S4, and if the answer is No, the process proceeds to step S7.

In step S4, the parallax adjustment unit 202 determines whether the representative parallax maximum value pmax is greater than the maximum display permissible parallax Dmax” or not. If the answer is Yes, the process proceeds to step S6, and if the answer is No, the process proceeds to step S5.

In step S5, the parallax adjustment unit 202 determines whether the representative parallax minimum value pmin is less than the minimum display permissible parallax Dmin” or not. If the answer is Yes, the process proceeds to step S6, and if the answer is No, the process proceeds to step S16.

In step S6, the parallax adjustment unit 202 shifts the representative parallax of each stereoscopic image frame such that the stereoscopic video parallax width fall in the display permissible parallax width. That is, if it is determined to be Yes in step S4, each representative parallax is shifted in a negative (down) direction so as to fall in the range of Dmax˜Dmin. If it is determined to be Yes in step S5, each representative parallax is shifted in a positive (up) direction so as to fall in the range of Dmax˜Dmin.

In step S7, a scene separation unit 206 detects a scene change of each stereoscopic image frame. A scene detection level by the scene separation unit 206 is variable. Here, the scene detection level is variable stepwise across levels 1 to 3. An initial detection level is level 1 when the step S7 is executed at first, until the level is changed in step S13 later, the scene change is detected in the initial detection level. In addition, it is assumed that the estimation accuracy of the scene change detection is decreased in the order of “level 1>level 2>level 3”.

A scene change detection method is different depending on the level. In the level 1 which has the highest estimation accuracy for the scene change detection, the scene change is detected on the basis of division assignment operation for a user's explicit scene input by the operation unit 25 or the like. For example, the stereoscopic image frame assigned to a scene division by an editing operation is detected as a scene changed stereoscopic image frame. The editing operation includes the assignment of cutting portions of the stereoscopic image frame within the stereoscopic video, the assignment of joint portions of the different stereoscopic video, or the like. The stereoscopic image frame where the release button 14 is turned on and off as a stereoscopic image frame with a scene change.

In the level 2 of which detection estimation accuracy is lower than the level 1, the stereoscopic image frames acquired at the time of zooming operation of the zoom lenses 18 using the zoom buttons 126 is detected as the stereoscopic image frame with the scene change.

In the level 3 of which detection estimation accuracy is lower than the level 2, when image information difference between two adjacent stereoscopic image frames a and b exceeds a predetermined threshold value, the stereoscopic image frame b is detected as the stereoscopic image frame with the scene change. This image information includes brightness information, color information, information (histogram or the like) in which these information items are statistically processed, or the like.

The scene detection method corresponding to each level may be freely set by a user through a scene separation information input unit 207. The scene separation information input unit 207 and the operation unit 25 may be used as a common means.

The scene separation unit 206 separates the stereoscopic video into n (n=2, 3 . . . ) numbers of sections on the basis of the stereoscopic image frames in which the scene change is detected. The stereoscopic video is divided into the stereoscopic image frames as the boundary of the detected scene change, and thereby each section in the separated stereoscopic video respectively configures the different scene. The scene separation unit 206 inputs the scene information showing the first stereoscopic image frame and the last stereoscopic image frame in each scene S(k) into the parallax adjustment unit 202. Here, k is 1 to n, but the initial value of k is “1”, and whenever the loop of S7 to S15 is repeated, the value of k is incremented by one.

In step S8, the parallax adjustment unit 202 specifies a representative parallax maximum value pmax (k) and a representative parallax minimum value pmin pmax(k) and a representative parallax minimum value pmin(k) from the representative parallax of each stereoscopic image frame inside the scene S(k) identified according to the scene information, and calculates the stereoscopic video parallax width by subtracting the representative parallax minimum value pmin(k) of the scene S(k) from the representative parallax maximum value pmax(k) of the scene S(k). Then, the parallax adjustment unit 202 determines whether the stereoscopic video parallax width of the scene S(k) is less than the display permissible parallax width or not. If the answer is Yes, the process proceeds to step S9, and if the answer is No, the process proceeds to step S12.

In step S9, the parallax adjustment unit 202 determines whether the representative parallax maximum value pmax(k) of the scene S(k) is greater than the maximum display permissible parallax Dmax or not. If the answer is Yes, the process proceeds to step S11, and if the answer is No, the process proceeds to step S10.

In step S10, the parallax adjustment unit 202 determines whether the representative parallax minimum value pmin of the scene S(k) is greater than the minimum display permissible parallax Dmin or not. If the answer is Yes, the process proceeds to step S11, and if the answer is No, the process proceeds to step S15.

In step S11, the parallax adjustment unit 202 shifts the representative parallax of the each stereoscopic image frame of the scene S(k) in the positive or negative direction such that the representative parallax of the scene S(k) falls in the range of Dmax to Dmin.

In step S12, the scene separation unit 206 determines whether a method of detecting a scene having a separation level lower than that of the currently set scene can be set or not. For example, in a case where the scene detection level varies across levels 1 to 3, if the currently set level is the level 1 or the level 2, the result is determined to be Yes, and if the currently set level is the level 3, the result is determined to be No.

In step S13, the scene separation unit 206 changes a scene separation level. For example, the scene separation unit 206 sets the level in which the estimation accuracy is one step lower than the currently set level as a new detection level. After that, the process returns to step S7, and the scene change in the stereoscopic video is detected in a new detection level. Alternatively, the scene change may be detected by both the previously set level and the currently set level.

In step S14, the parallax adjustment unit 202 adjusts the representative parallax of each stereoscopic image frame of the scene S(k) such that the stereoscopic video parallax width of the scene S(k) falls in the display permissible parallax width. For example, in a case where the stereoscopic video parallax width of the scene S(k) represents X, the display permissible parallax width represents Y, and X is greater than Y, the representative parallax of each stereoscopic image frame of the scene S(k) is reduced in a uniform reduction ratio of (X−Y)/X.

In step S15, the CPU 26 determines whether k is equal to n or not, that is, whether the loops of S7˜S15 are executed on the entire scenes S(1) to S(n) or not. If the answer is Yes, the process proceeds to step S16, and if the answer is No, the process returns to step S8 by incrementing a value of k by one.

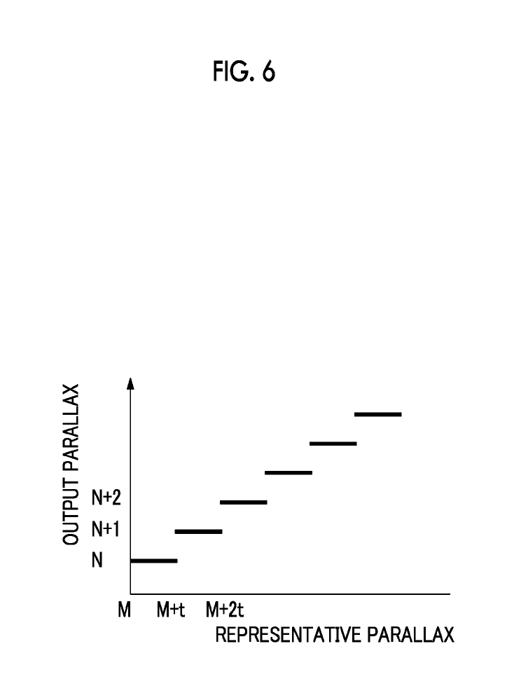

In step S16, the parallax adjustment unit 202 reads out the conversion table of the stereoscopic video parallax and the output parallax stored in the ROM 61 or the like to the SRDRAM 39. FIG. 6 illustrates an example of the conversion table of the stereoscopic video parallax and the output parallax. This table defines integer output parallax corresponding to the representative parallax of arbitrary value of each stereoscopic image frame. For example, according to this table, the representative parallax of M to M+t corresponds to N of the output parallax, and the representative parallax of M to M+2t corresponds to N+1 of the output parallax. In addition, since the minimum display unit of the images is one pixel, if the output parallax is illustrated in the pixel unit, they become integers.

The parallax adjustment unit 202 determines the output parallax corresponding to the representative parallax (the representative parallax after being shifted or after being reduced is included) of each stereoscopic image frame according to the conversion table of the stereoscopic video parallax and output parallax stored in the ROM 61 or the like.

The display control unit 42 reproduces the stereoscopic video by sequentially displaying each stereoscopic image frame on the monitor 13 by using the determined output parallax.

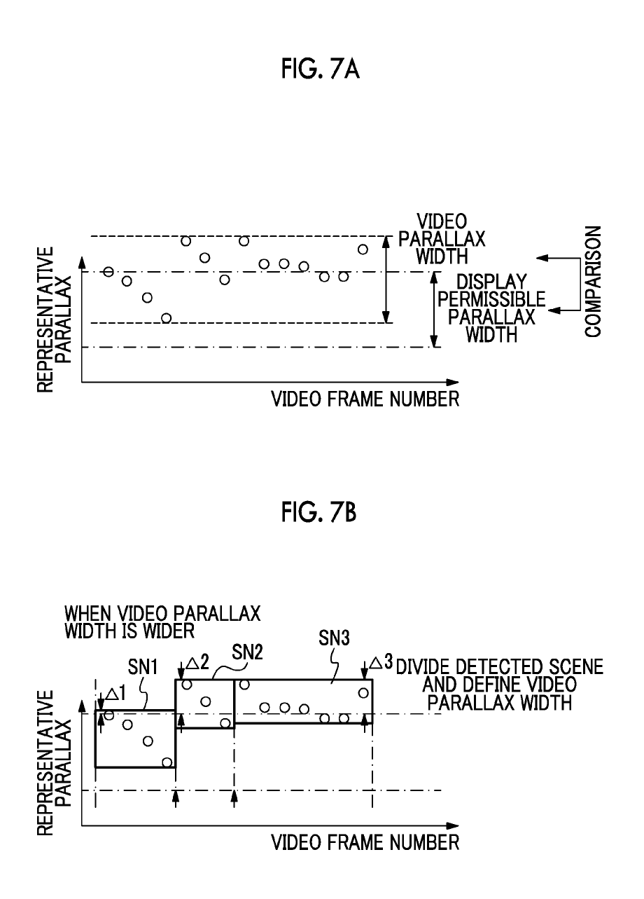

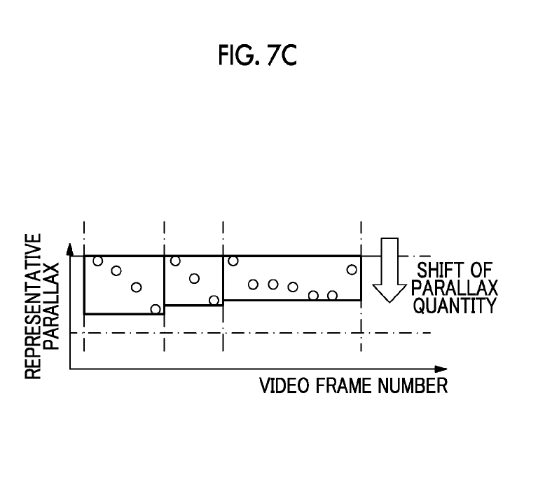

FIGS. 7A to 7C exemplify aspects of the parallax adjustment unit according to the present process.

For example, as illustrated in FIG. 7A, the video parallax width of a certain stereoscopic video exceeds the display permissible parallax width. In this case, the answer in the step S3 is No, the scene separation of this video is executed in step S7. FIG. 7B exemplifies the separated scenes. In FIG. 7B, the stereoscopic video is separated into three scenes SN1 to SN3.

After the scenes are separated, in step S8, the video parallax width of each scene is compared with the display permissible parallax width. When the video parallax width of each scene exceeds the display permissible parallax width, the answer in the step S8 is No, and in step S13, the scene change detection level is changed and the scene change is detected again at the level after the change.

When the video parallax width of each scene does not exceed the display permissible parallax width, the answer in the step S8 is Yes, and in step S9 and/or S10, it is determined where the representative parallax is required to be shifted with regard to the scene or not. When the maximum parallax of the scene is determined to exceed the maximum display permissible parallax in step S9, or the minimum parallax of the scene is determined to be lower than the minimum display permissible parallax in step S10, the representative parallax of each stereoscopic image frame included in the related scene in step S11 is shifted so as to fall in the range between the minimum value of the display permissible parallax and the maximum value of the display permissible parallax.

FIG. 7C exemplifies a state where the representative parallax for each separated scene is shifted. In FIG. 7C, each representative parallax of the scene SN1 is uniformly shifted down by Δ1, each representative parallax of the scene SN2 is uniformly shifted down by Δ2, and each representative parallax of the scene SN3 is uniformly shifted down by Δ3.

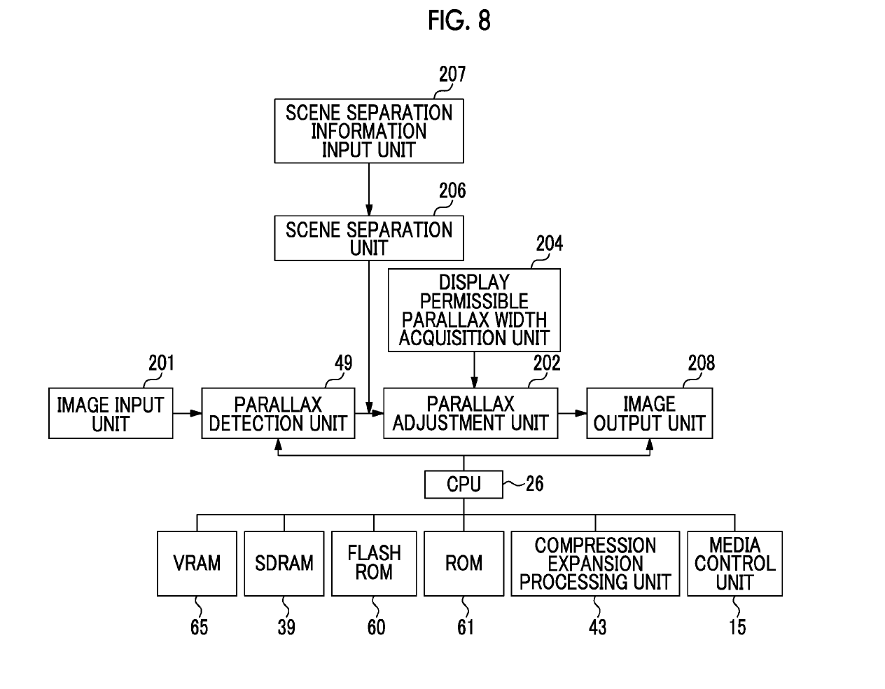

A block necessary to execute the above process may be included in an electronic device other than the digital camera. For example, this process may be executed by an image output device including a block for displaying a plan view or a stereoscopic image such as the CPU 26, the VRAM 65, the SDRAM 39, the flash ROM 60, the ROM 61, the compression expansion processing unit 43, the media control unit 15, the parallax detection unit 49, the parallax adjustment unit 202, the image input unit 201 (for example, the image input controllers 38, the media control unit 15 or the like), the display permissible parallax acquisition unit 204, the scene separation unit 206, the scene separation information input unit 207, the image output unit 208 (for example, the monitor 13, the media control unit 15 or the like) and the like, as illustrated in FIG. 8,

The stereoscopic video input to the image input unit 201 is not limited to the one directly output from photographing means. For example, the stereoscopic video may be to the one read out from media such as the memory card 16 by the media control unit 15, or the one received through networks.

The destination to which the image output unit 208 outputs the parallax adjusted image is not limited to the display control unit 42 and the monitor 13, and the image may not be displayed immediately after the parallax adjustment. For example, the media control unit 15 may record the representative parallax after the stereoscopic image frames are adjusted, that is, the output parallax, on the media such as the memory card 16, as stereoscopic video data corresponding to each stereoscopic video frame. Alternatively, the stereoscopic video data may be transmitted through the networks. Alternatively, each stereoscopic image frame may be configured by printed matter such as a lenticular print material.

In addition, mode setting or timing which determines whether to operate the parallax adjustment process is arbitrary. For example, when a photographing mode is started, the parallax adjustment process is not performed, but when the release button 14 is fully pressed, the parallax adjustment process is started. Alternatively, when the stereoscopic video data on the memory card 16 is displayed on an external monitor 13 such as a television, the parallax adjustment process is started.

According to the above processes, when the representative parallax of each stereoscopic image frame exceeds the display permissible parallax width, it is determined whether the parallax width is compressed for each scene or not, and the parallax width is adjusted by the scene unit. Accordingly, the representative parallax of the stereoscopic video at the time of photographing can be maintained and output.

### Second Embodiment

If the parallax quantity is adjusted for each scene, an output parallax variation according to a scene change becomes different from the original parallax variation at the time of photographing which may impart a sense of discomfort to viewers. As a result, in step S11, the parallax adjustment unit 202 further determines whether the parallax width of neither scene S(k−1)•nor S(k) with regard to the current scene S(k) and the previous scene S(k−1) (however, herein 2<k≦n) exceed the display permissible parallax width, and in a case where the parallax width of either scene S(k−1)•nor S(k) is determined to exceed the display permissible parallax width, the scene S(k) may be shifted within the display permissible parallax width by the common shift amount to the scene S(k−1). This process is repeated according to the increment of the “k”, if no video parallax width of the two consecutive scenes exceeds the display permissible parallax width, the two consecutive scenes are shifted up or down by the shift amount so as to fall in the range of the display permissible parallax.

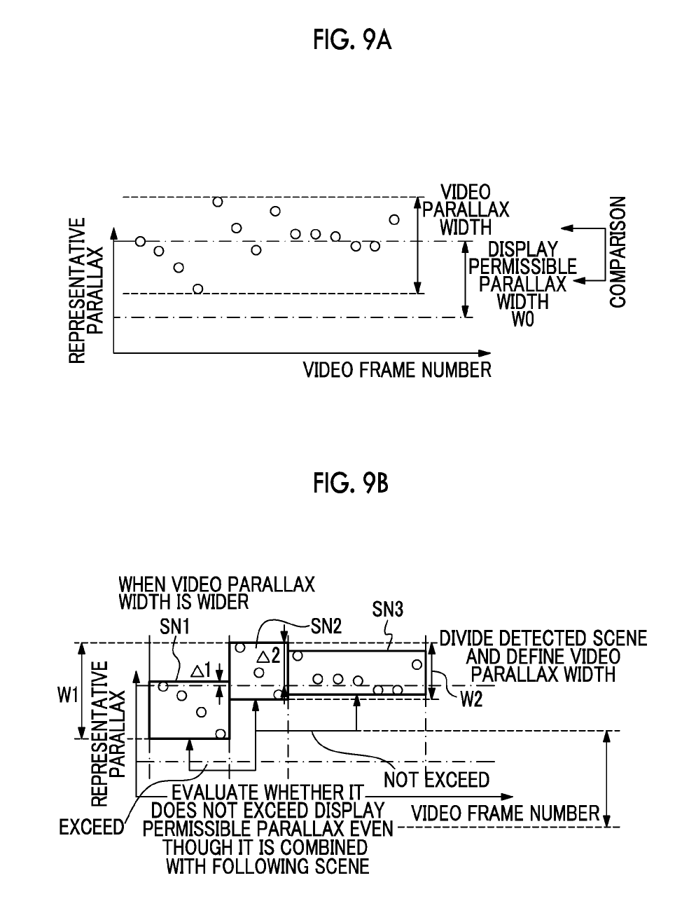

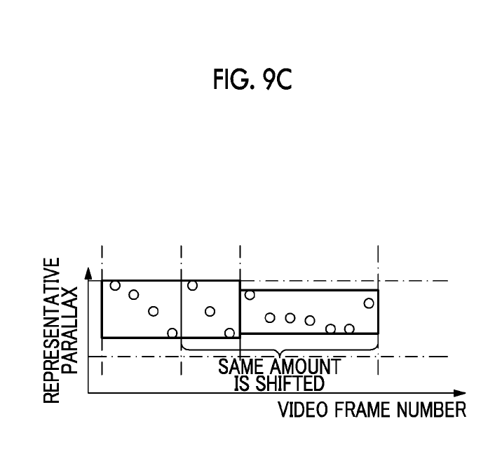

For example, as illustrated in FIG. 9A, the representative parallax of the stereoscopic frame in a certain stereoscopic video is assumed to be transitioned. FIG. 9B exemplifies the scenes separated from this stereoscopic video. In FIG. 7B, the stereoscopic video is separated into three scenes SN1˜SN3.

A parallax width W1 in the two scenes SN1 and SN2 exceeds the display permissible parallax width W0. On the other hand, a parallax width W2 in the two scenes SN2 and SN3 does not exceed the display permissible parallax width W0. In this case, in steps S9 and S10, it is determined whether or not the representative parallax is required to be shifted with regard to the two scenes SN2 and SN3. In a case where the maximum parallax of the related scene is determined to exceed the maximum display permissible parallax in step S9, or the minimum parallax of the scene is determined to be lower than the minimum display permissible parallax in step S10, the representative parallax of each stereoscopic image frame included in the two scenes SN2 and SN3 is shifted so as to fall in the display permissible parallax width in step S11.

FIG. 9C exemplifies a state where the representative parallax is shifted for each separated scene. In FIG. 9C, each representative parallax of the scene SN1 is uniformly shifted down by Δ1, each representative parallax of the scenes SN2 and SN3 is uniformly shifted down by Δ2,

In this way, in a case where the parallax width of the representative parallax of the two consecutive scenes falls in the display permissible parallax width, if the shift amount of the representative parallax of the two consecutive scenes is set to be a common value, parallax transition before and after the scene change becomes similar to that at the time of photographing, and it is easy for the viewers to view the stereoscopic images.

### Third Embodiment

In the first embodiment or the second embodiment, if the difference of representative parallax adjustment amount (representative parallax change amount due to the parallax width reduction and/or change quantity due to the representative parallax shift) between the adjacent scenes is large, there is a high possibility that the subject distance may be rapidly changed during the change between the scenes. As a result, in a case where the difference of the representative parallax adjustment amount between the scenes is equal to or higher than a predetermined threshold, the representative parallax adjustment amount between the scenes may be smoothed.

In particular, a scene A and a scene B are temporally adjacent to each other, the representative parallax adjustment amount of the scene A is denoted by a, and the representative parallax adjustment amount of the scene B is denoted by b. The parallax adjustment unit 202 determines whether an absolute value of “a−b” is less than a predetermined threshold (for example 5 pixels) or not. In a case where the answer is No, the parallax adjustment unit 202 smoothes the representative parallax adjustment amount a of the scene A and the representative parallax adjustment amount b of the scene B within a predetermined range.

For example, the parallax adjustment unit 202 gradually changes the parallax adjustment amount from a to b between the stereoscopic image frame of the head of the scene B and the stereoscopic image frame advancing by approximately 100 frames. Alternatively, the parallax adjustment unit 202 gradually changes the parallax adjustment amount from a to b between the stereoscopic image frame retroactive by approximately 50 frames from the last end of the scene A and the stereoscopic image frame advancing by approximately 50 frames from the head of the scene B. In this manner, the rapid change of the parallax adjustment amount due to the scene change can be reduced. In addition, the change of the parallax adjustment amount between the scenes may be performed according to a predetermined function having a time axis as a parameter, for example a primary function.

What is claimed is:

1. An image processing device comprising:
a representative parallax acquisition unit that acquires a representative parallax from a plurality of stereoscopic image frames configuring the whole or a predetermined partial range of a stereoscopic video;
a scene separation unit that separates the stereoscopic video into a plurality of scenes, in a case where a parallax width stipulated by a maximum value and a minimum value of the representative parallax of each stereoscopic image frame acquired by the representative parallax acquisition unit does not conform to a permissible parallax width stipulated by a predetermined maximum permissible parallax width and minimum permissible parallax width;
a parallax adjustment unit that determines whether or not the scene parallax width stipulated by the maximum value and the minimum value of the representative parallax of the stereoscopic image frames configuring the scenes conforms to the permissible parallax width, for each scene separated by the scene separation unit, and that uniformly adjusts the representative parallax of each stereoscopic image frame configuring the scenes according to the determining result so as to conform to the permissible parallax width; and
an output unit that outputs the stereoscopic image frame of which the representative parallax is adjusted by the parallax adjustment unit.

2. The image processing device according to claim 1,
wherein the parallax adjustment unit adjusts the representative parallax of each stereoscopic image frame configuring an arbitrary scene so as to be equal to or lower than an upper limit of the representative parallax, in a case where scene parallax width of the arbitrary scene conforms to the permissible parallax width, but the maximum value of the representative parallax of the stereoscopic image frames configuring the arbitrary scene exceeds the upper limit of a predetermined representative parallax.

3. The image processing device according to claim 2,
wherein the parallax adjustment unit uniformly adjusts the representative parallax of so that the representative parallax each stereoscopic image frame configuring two or more consecutive scenes is equal to or lower than the upper limit of the representative parallax, in a case where the parallax width of each scene corresponding to two or more consecutive scenes conforms to the permissible parallax width, but the maximum value of the representative parallax of the stereoscopic image frames configuring the two or more consecutive scenes exceed the upper limit of the representative parallax.

4. The image processing device according to claim 1,
wherein the parallax adjustment unit adjusts the representative parallax of each stereoscopic image frame configuring the arbitrary scene so as to be equal to or higher than a lower limit of the representative parallax, in a case where the scene parallax width of the arbitrary scene conforms to the permissible parallax width, but the minimum value of the representative parallax of the stereoscopic image frames configuring the arbitrary scene is less than the lower limit of a predetermined representative parallax.

5. The image processing device according to claim 2,
wherein the parallax adjustment unit adjusts the representative parallax of each stereoscopic image frame configuring the arbitrary scene so as to be equal to or higher than a lower limit of the representative parallax, in a case where the scene parallax width of the arbitrary scene conforms to the permissible parallax width, but the minimum value of the representative parallax of the stereoscopic image frames configuring the arbitrary scene is less than the lower limit of the predetermined representative parallax.

6. The image processing device according to claim 3,
wherein the parallax adjustment unit adjusts the representative parallax of each stereoscopic image frame configuring the arbitrary scene so as to be equal to or higher than a lower limit of the representative parallax, in a case where the scene parallax width of the arbitrary scene conforms to the permissible parallax width, but the minimum value of the representative parallax of the stereoscopic image frames configuring the arbitrary scene is less than the lower limit of the predetermined representative parallax.

7. The image processing device according to claim 4,
wherein the parallax adjustment unit uniformly adjusts the representative parallax of each stereoscopic image frame configuring two or more consecutive scenes so as to be equal to or higher than the lower limit of the representative parallax, in a case where each scene the parallax width corresponding to two or more consecutive scenes conforms to the permissible parallax width, but the minimum value of the representative parallax of the stereoscopic image frames configuring the two or more consecutive scenes is less than the lower limit of the representative parallax.

8. The image processing device according to claim 1,
wherein the scene separation unit separates the stereoscopic video according to a first predetermined reference and a second reference other than the first predetermined reference, in a case where the scene parallax width of scenes separated according to the first predetermined reference does not conform to the permissible parallax width.

9. The image processing device according to claim 2,
wherein the scene separation unit separates the stereoscopic video according to a first predetermined reference and a second reference other than the first predetermined reference, in a case where the scene parallax width of scenes separated according to the first predetermined reference does not conform to the permissible parallax width.

10. The image processing device according to claim 3,
wherein the scene separation unit separates the stereoscopic video according to a first predetermined reference and a second reference other than the first predetermined reference, in a case where the scene parallax width of scenes separated according to the first predetermined reference does not conform to the permissible parallax width.

11. The image processing device according to claim 4,
wherein the scene separation unit separates the stereoscopic video according to a first predetermined reference and a second reference other than the first predetermined reference, in a case where the scene parallax width of scenes separated according to the first predetermined reference does not conform to the permissible parallax width.

12. The image processing device according to claim 8,
wherein the second reference has a lower estimation accuracy of the scene change than that of the first reference.

13. The image processing device according to claim 8,
wherein the parallax adjustment unit determines whether or not the scene parallax width of the scenes conforms to the permissible parallax width, for each scene separated by the scene separation unit according to the first reference and the second reference, and adjusts the representative parallax of each stereoscopic image frame configuring the scenes so as to conform to the permissible parallax width, in a case where it is determined that the scene parallax width of the scenes does not conform to the permissible parallax width.

14. The image processing device according to claim 9,
wherein the parallax adjustment unit determines whether or not the scene parallax width of the scenes conforms to the permissible parallax width, for each scene separated by the scene separation unit according to the first reference and the second reference, and adjusts the representative parallax of each stereoscopic image frame configuring the scenes so as to conform to the permissible parallax width, in a case where it is determined that the scene parallax width of the scenes does not conform to the permissible parallax width.

15. The image processing device according to claim 10,
wherein the parallax adjustment unit determines whether or not the scene parallax width of the scenes conforms to the permissible parallax width, for each scene separated by the scene separation unit according to the first reference and the second reference, and adjusts the representative parallax of each stereoscopic image frame configuring the scenes so as to conform to the permissible parallax width, in a case where it is determined that the scene parallax width of the scenes does not conform to the permissible parallax width.

16. The image processing device according to claim 11,
wherein the parallax adjustment unit determines whether or not the scene parallax width of the scenes conforms to the permissible parallax width, for each scene separated by the scene separation unit according to the first reference and the second reference, and adjusts the representative parallax of each stereoscopic image frame configuring the scenes so as to conform to the permissible parallax width, in a case where it is determined that the scene parallax width of the scenes does not conform to the permissible parallax width.

17. The image processing device according to claim 12,
wherein the parallax adjustment unit determines whether or not the scene parallax width of the scenes conforms to the permissible parallax width, for each scene separated by the scene separation unit according to the first reference and the second reference, and adjusts the representative parallax of each stereoscopic image frame configuring the scenes so as to conform to the permissible parallax width, in a case where it is determined that the scene parallax width of the scenes does not conform to the permissible parallax width.

18. The image processing device according to claim 1,
wherein the parallax adjustment unit smoothes a representative parallax adjustment amount between the two adjacent scenes, in a case where a difference of the representative parallax adjustment amount between the two adjacent scenes exceeds a predetermined threshold value.

19. An image processing method using the image processing device according to claim 1, comprising:
an acquisition step of acquiring a representative parallax for a plurality of stereoscopic image frames configuring the whole or a predetermined partial range of a stereoscopic video;
a separation step of separating the stereoscopic video into a plurality of scenes, in a case where a parallax width stipulated by a maximum value and a minimum value of the representative parallax of each stereoscopic image frame acquired by the representative parallax acquisition unit does not conform to a permissible parallax width stipulated by a predetermined maximum permissible parallax width and a predetermined minimum permissible parallax width;
an adjustment step of determining whether or not the scene parallax width stipulated by the maximum value and the minimum value of the representative parallax of each stereoscopic image frame configuring the scenes conforms to the permissible parallax width, for each scene separated by the scene separation unit, and of uniformly adjusting the representative parallax of each stereoscopic image frame configuring the scenes according to the determining result so as to conform to the permissible parallax width; and
an output step of outputting the stereoscopic image frame of which the representative parallax adjusted.

20. A non-transitory (non-transitory) computer-readable recording medium using the image processing device according to claim 1, which stores an image processing program for performing:
an acquisition step of acquiring a representative parallax for a plurality of stereoscopic image frames configuring the whole or a predetermined partial range of a stereoscopic video;
a separation step of separating the stereoscopic video into a plurality of scenes, in a case where a parallax width stipulated by a maximum value and a minimum value of the representative parallax of each stereoscopic image frame acquired by the representative parallax acquisition unit does not conform to a permissible parallax width stipulated by a predetermined maximum permissible parallax width and a predetermined minimum permissible parallax width;
a adjustment step of determining whether or not the scene parallax width stipulated by the maximum value and the minimum value of the representative parallax of each stereoscopic image frame configuring the scenes conforms to the permissible parallax width, for each scene separated by the scene separation unit, and of uniformly adjusting the representative parallax of each stereoscopic image frame configuring the scenes according to the determining result so as to conform to the permissible parallax width; and
an output step of outputting the stereoscopic image frame of which the representative parallax is adjusted.
